(19) United States
(12) Patent Application Publication
(10) Pub. No.: US 2011/0142991 A1
(43) Pub. Date: Jun. 16, 2011

(54) Method for treating feed silage for ruminants and feed silage additive

(76) Inventors: Eva Maria Binder, Tulln (AT); Sigrid Pasteiner, St. Polten (AT); Yunior Acosta Aragon, St. Polten (AT)

(21) Appl. No.: 12/929,816

(22) Filed: Feb. 17, 2011

Related U.S. Application Data
(63) Continuation of application No. PCT/AT09/00256, filed on Jun. 26, 2009.

(30) Foreign Application Priority Data
Jul. 21, 2008 (AT) GM396/2008

(51) Int. Cl. A23K 1/18; A23K 1/00

(52) U.S. Cl. 426/53; 426/62

(57) ABSTRACT

In a method for treating feed silage for ruminants, by which silage is mixed with a microorganism and the mixture of feed silage and microorganism is stored in a closed container for at least 30 days, it is provided that the feed silage is mixed with at least two microorganisms selected from the group consisting of Enterococcus faecium (DSM 3530), Lactobacillus brevis (DSM 19456), Lactobacillus plantarum (DSM 19457), Lactobacillus kefiri (DSM 19455), Trichosporon spec. nov. (DSM 14153), Trichosporon mucoides (DSM 14156), Trichosporon dulcitum (DSM 14162) and Eubacterium (DSM 11798), as well as an inorganic substance having a large internal surface area.

In addition, a feed silage additive for ruminants is provided.

This is a continuation of PCT/AT09/000,256 filed Jun. 26, 2009 and published in German, which has a priority of Austria number GM 396/2008 filed Jul. 21, 2008, hereby incorporation by reference.

The present invention relates to a method for treating feed silage for ruminants, by which silage is mixed with a microorganism and the mixture of feed silage and microorganism is stored in a closed container for at least 30 days, and to a feed silage for ruminants, containing silage of grass or hey, cereals, maize and/or lucernes as well as a microorganism.

Feed silage has been produced for numerous years, in particular for feeding ruminants, either in special feed silos provided therefor or also in special, air-tight silage bales, since, by feeding silage, the stability of the feed is improved, on the one hand, and ruminants can be supplied with the necessary energy-rich feed, on the other hand.

When treating agricultural raw materials for the production of feed silage, the raw material, in particular grass, maize or the like, is mixed with lactic acid bacteria, what is called ensilage, which is a well-known method for increasing the stability of such products, on the one hand, and also change or improve the properties of the raw materials, on the other hand. For the production of such silages, both maize and grasses, millet, cereals with or without grains and leguminous plants are suitable as raw materials. To produce silages, silaging aids, so-called silage starters, are frequently used, comprising both chemical additives and microbial additives.

From EP 0 880 323 B, a method for producing silage by adding microbial additives can be taken. The addition of microorganisms having the characteristics of a special microorganism, namely Lactobacillus buchneri, NCIMB 40788, produces silages which, in addition to the fatty acids normally produced during fermentation, produce a secondary metabolite with the property of inhibiting the growth of contaminative organisms.

The addition of microorganism according to EP 0 880 323 B results in a certain inhibition of microorganisms, yet, apart from these positive effects, there is no way to influence the methane emissions of ruminants, which is of particular importance and severity in the keeping of ruminants, by such a method for producing silage.

The present invention aims to provide a method for producing silage as well as a feed silage additive, which, in addition to reducing mycotoxins in animal feed are, in particular, able to lower the methane emissions of ruminants.

To solve this object, the method according to the invention for treating feed silage for ruminants is essentially characterized in that the feed silage is mixed with at least two microorganisms selected from the group consisting of Enterococcus faecium (DSM 3530), Lactobacillus brevis (DSM 19456), Lactobacillus plantarum (DSM 19457), Lactobacillus kefiri (DSM 19455), Trichosporon spec. nov. (DSM 14153), Trichosporon mucoides (DSM 14156), Trichosporon dulcitum (DSM 14162) and Eubacterium (DSM 11798), as well as an inorganic substance having a large internal surface area. By mixing the feed silage with at least two microorganisms selected from the group consisting of Enterococcus faecium (DSM 3530), Lactobacillus brevis (DSM 19456), Lactobacillus plantarum (DSM 19457), Lactobacillus kefiri (DSM 19455), Trichosporon spec. nov. (DSM 14153), Trichosporon mucoides (DSM 14156), Trichosporon dulcitum (DSM 14162) and Eubacterium (DSM 11798), as well as, in addition, an inorganic substance having a large internal surface area, it is feasible, on the one hand, to drastically reduce the noxious mycotoxins in the feed or silage and, on the other hand, to also drastically reduce the methane emissions of ruminants in addition to the positive effects as are, for instance, partially described in EP 0 880 323 B. This reduction is, in particular, also clearly superior to that investigated, for instance, with various known feed additives in terms of their effectiveness to reduce methane emissions, such as various oils and tannins, so that it can be concluded that, in particular, by the use of at least two microorganisms and an inorganic substance having a large internal surface area the noxious mycotoxins will be degraded in the feed silage, and even in the digestive tract of the animals, to such an extent that the latter will not or only negligibly contribute to the production of methane.

By selecting the bacteria or yeasts from the above-identified group, not only the fermentability of the feed in the rumen of a ruminant will be enhanced, but also an increased aerobic stability of the feed will be achieved, the energy content of the feed will be improved and the negative effects of mycotoxins will be almost completely excluded or inhibited. By excluding the negative effects of mycotoxins, not only the production performance of the animals in terms of milk and/or meat yield will be enhanced, but also their methane emissions will be significantly lowered by at least 15% as against silage treated with known substances.

According to a preferred further development of the invention, the method according to the invention is performed in that two microorganisms from the group of yeasts and/or bacteria, in particular each a heterofermentative microorganism and a homofermentative microorganism, and an inorganic material are used as microorganisms. By adding at least one heterofermentative microorganism or one homofermentative microorganism and an inorganic material, it is feasible to degrade the mycotoxins as completely as possible in the silage and during the digestion in the digestive tract of the animals such that, in addition to an increase in the stability of the products, and in addition to the known property of changing or improving the properties of the raw materials, particularly on account of the enhanced fermentability of the feed in the rumens of ruminants, a positive influence on the methane emission will be achieved.

By performing the method according to the invention in such a manner that the feed silage is each supplemented with equal amounts of at least one microorganism from the group of bacteria and one microorganism from the group of yeasts, it is feasible to achieve a nearly complete degradation of mycotoxins in the thus produced feed silage and the digestive tract of animals, respectively, so as to significantly enhance the production performance of ruminants fed with a feed produced according to a method of this type.

By performing the method in such as manner as to select the inorganic substance having a large internal surface area from silicates, in particular aluminium silicates, diatomaceous earths, zeolites and/or bentonite, further impurities present on or in the silage raw material will be readily and efficiently bound by the inorganic substance having a large internal surface area such that not only the mycotoxins but also other substances possibly harmful to ruminants will be safely and reliably diverted from resorption in the animal organism.

Aluminium silicate as well as, in particular, acid-treated or granulated aluminium silicate have proved to be particularly beneficial for such purposes of use and to particularly markedly increase the production performance of the animals.

The invention further aims to provide a feed silage additive by which the methane emission of ruminants can be lowered.

To solve this object, the feed silage additive according to the invention is essentially characterized in that the feed silage additive is comprised of at least two microorganisms selected from the group consisting of Enterococcus faecium (DSM 3530), Lactobacillus brevis (DSM 19456), Lactobacillus plantarum (DSM 19457), Lactobacillus kefiri (DSM 19455), Trichosporon spec. nov. (DSM 14153), Trichosporon mucoides (DSM 14156), Trichosporon dulcitum (DSM 14162) and Eubacterium (DSM 11798), and an inorganic substance having a large internal surface area. In that the feed silage additive is comprised of at least two microorganisms selected from the group consisting of Enterococcus faecium (DSM 3530), Lactobacillus brevis (DSM 19456), Lactobacillus plantarum (DSM 19457), Lactobacillus kefiri (DSM 19455), Trichosporon spec. nov. (DSM 14153), Trichosporon mucoides (DSM 14156), Trichosporon dulcitum (DSM 14162) and Eubacterium (DSM 11798), and an inorganic substance having a large internal surface area, it is feasible to almost completely render harmless, or bind, the mycotoxins contained in the silage raw material such as grasses, cereals, maize, lucernes and the like, thus providing not only an enhanced production performance of the ruminants but, in particular, also lowering the methane emissions of the ruminants by at least 15% as against conventional silages.

In that the two microorganisms are selected from the group of yeasts and/or bacteria and are, in particular, selected from each a heterofermentative microorganism and a homofermentative microorganism, it is feasible to simultaneously render harmless the most diverse mycotoxins contained in the silage raw material so as to further improve the methane balance of the animals.

By selecting at least two from the special bacteria and/or yeasts, the mycotoxins contained in the feed are almost completely degraded while, at the same time, an enhanced fermentability of the feed is achieved, whereby also an increased aerobic stability of the feed will be ensured so as to improve the energy content, on the one hand, and almost completely exclude the negative effects of the mycotoxins, on the other hand.

By further developing the invention to the effect that the feed silage additive is designed such that the feed silage respectively contains at least one microorganism from the group of bacteria and one microorganism from the group of yeasts, the substantially complete spectrum of mycotoxins possibly contained in the feed will simultaneously be degraded or immobilized so as to further improve the methane balance of the animals.

In that, in the feed silage additive according to the present invention, the inorganic substance having a large internal surface area is selected from silicates and, in particular, aluminium silicates, diatomaceous earths, zeolites and/or bentonite, further noxious components possibly contained in the silage will be safely and reliably immobilized or bound so as to ensure a further decrease of pathogenic substances in the feed silage, which will in turn further enhance the production performance of the animals. In this respect, the addition of aluminium silicate, in particular acid-treated granulated aluminium silicate, has proved to be of particularly advantage.

In the following, the invention will be explained in more detail by way of exemplary embodiments. Therein:

Experiment 1 illustrates the effect of feed silage supplemented with the feed silage additive according to the present invention in a rumen simulation technique test;
Experiment 2 represents a feeding test with calves;
Experiment 3 represents a feeding test with sheep;
Experiment 4 represents a feeding test with dairy cows;
Experiment 5 represents a feeding test with calves; and
Experiment 6 represents a feeding test with young cattle.

### EXPERIMENT 1

Two feed formulations were investigated using a rumen simulation technique (Rusitec). In doing so, 900 ml rumen fluid obtained from fistulated cows was filled into fermenters and mixed with 100 ml McDougall buffer; in the continuous system, 500 ml fluid per day was each replaced with a buffer, the test itself lasting for 10 days. Feed was daily admixed and incubated, the feed in the test group comprising whole grain maize silage treated in equal shares with Lactobacillus kefiri (DSM 19455) and Enterococcus faecium (DSM 3530) as well as acid-treated granulated aluminium silicate. The control groups received feed with conventionally treated whole grain maize silage, one having been treated with a chemical silage starter and the other having been treated with a microbial silage starter. The mycotoxin analysis revealed a contamination of 382 μg/kg aflotoxin B1 and 2095 μg/kg fumonsin B1 and B2. In the group fed with whole grain silage treated by the method according to the invention, the methane production was significantly lower (P<0.05) as compared to the other groups.

TABLE 1
Methane emission, in-vitro test

| | Methane emission |
|---|---|
| | [mmol/day] |
| Feed with whole grain silage | 3.34^{a} |
| treated with Lactobacillus | |
| kefiri (DSM 19455), | |
| Enterococcus faecium (DSM 3530) | |
| and acid-treated granulated | |
| aluminium silicate | |
| Feed containing whole grain | 7.67^{b} |
| silage treated with checmical | |
| additive | |
| Feed containing whole grain | 6.92^{b} |
| silage treated with a microbial | |
| additive | |

### EXPERIMENT 2

Two groups of three calves each (Holstein), over a period of four weeks, received either a feed formulation A containing silage treated with Lactobacillus kefiri (DSM 19455) and Eubacterium (DSM 11798) as well as Trichosporon mucoides (DSM 14156) and bentonite or a feed formulation B containing silage with a conventional microbial silaging agent consisting of Lactobacillus buchneri. The methane emission was collected in a respiration chamber at three measuring intervals of 22 h each. Animals which had received the feed formulation A showed a reduced methane emission of 16.7% relative to the animals fed with ration B. In addition, also the performance data of the animals in group A were enhanced over those of the animals in group B.

TABLE 2
Weight development (kg)

| | Test day 1 | Test day 28 |
|---|---|---|
| Group A | 48.3 ± 1.2 | 66.7 ± 2.8 |
| Group B | 48.8 ± 1.5 | 65.3 ± 3.2 |

### EXPERIMENT 3

Nine castrated male sheep were divided into three homogenous groups of three animals each, the groups each having received one of the three different feed formulations: (a) feed, whole grain maize silage treated according to the present invention with Lactobacillus brevis (DSM 19456), Trichosporon spec. nov. (DSM 14153) and acid-treated granulated aluminium silicate; (b) feed with whole grain maize silage treated with a chemical silaging agent; (c) feed with whole grain maize silage treated with a microbial silaging agent; the mycotoxin concentration of the feed was 532 μg/kg aflatoxin, 1887 μg/kg fumonisin B1. The animals were kept in a respiration chamber, and the gas exchange was measured in two 24-hour measuring periods. In the group receiving feed treated according to the invention, the methane emission could be reduced by 15.2% over the group with chemically treated silage, and by 13.1% over the group with microbiologically treated silage.

### EXPERIMENT 4

Three groups of six dairy cows each (race: Holstein-Friesian) each received one of three different feed mixtures over a period of two weeks: (a) feed, maize silage treated with Lactobacillus kefiri (DSM 19455), Enterococcus faecium (DSM 3530), Trichosporon mucoides (DSM 14156) and acid-treated granulated aluminium silicate; (b) feed with maize silage treated with a chemical silaging agent; (c) feed with maize silage treated with a microbial silaging age. The aflatoxin B1 content of the maize silage was 194 mg/kg. The methane emission of two animals each from each group was determined in a respiration chamber over a period of 24 h. In addition, the milk yield was collected from all animals, and the transfer of aflatoxin B1 to aflatoxin M1 into the milk was analyzed. The group fed with the silage treated according to the invention showed a reduced methane emission (minus 12.1% as against (b), minus 11.4% as against (c), at an enhanced milk yield ((a): 31.5±6.1 kg/day; (b): 30.6±6.9 kg/day; (c): 30.6±6.5 kg/day) and a reduced aflatoxin carry-over.

TABLE 3
Aflatoxin M1 contents (ng/kg) in milk

| | Group (a) | Group (b) | Group (c) |
|---|---|---|---|
| Test day 4 | 12 | 124 | 112 |
| Test day 7 | 11 | 157 | 136 |
| Test day 11 | 12 | 162 | 151 |
| Test day 14 | 8 | 181 | 143 |

### EXPERIMENT 5

Two groups of 12 calves each (Simmental) aged about 5 weeks received two different feed formulations over a period of 12 weeks: (a) feed, maize silage treated with Enterococcus faecium (DSM 3530), Trichosporon dulcitum (DSM 14162) and a natural zeolite; (b) feed with maize silage treated with a microbial silaging agent (Lactobacillus kefiri). The aflatoxin content of the silage was 112 mg/kg. The methane, emission was each measured for one animal from each group. Group (a) showed a reduced emission of 28% over group (b) (32.3 l/day in group (a), 44.8 l/day in group (b)), an improved weight development at a reduced feed conversion ratio ((a): 1.65; (b): 1.70).

TABLE 4
Weight development (average weights in kg)

| | Test start | Test end (12 weeks) |
|---|---|---|
| Group (a) | 90.3 | 167.9 |
| Group (b) | 89.8 | 160.4 |

### EXPERIMENT 6

Sixty male cattle (Simmental) aged about 6 months were divided into two groups of 30 animals each and, in addition to the conventional standard diet, were administered a feed additive consisting of a homofermentative microorganism, L. plantarum (DSM 19457), as well as a heterofermentative microorganism, L. brevis (DSM 19456), on montmorillonite in the test group, and in the control group only montmorillonite as an additive, at a dosage of 30 g feed additive each per animal and day. In the feed concentrate, triticales and maize were substituted for by maize contaminated with about 12 ppm deoxynivalenol such that the deoxynivalenol concentration in the feed concentrate was about 4 ppm. The methane emission was measured for one animal each per group: the animal of the test group showed a CH₄ emission reduced by about 15% relative to that of the animal from the control group, at an average improvement in the weight gain by 6.96%.

TABLE 5

| | Control | Test group |
|---|---|---|
| Dosage (g additive per animal and | 30 | 30 |
| day | | |
| Number of animals | 30 | 30 |
| Starting weight (kg) | 160.92 | 160.68 |
| Final weight (kg) | 348.47 | 362.27 |
| Average weight gain per animal (g) | 187.55 | 201.59 |
| Dropouts | — | — |
| Veterinary treatments | — | — |

1. A method for treating feed silage for ruminants, by which silage is mixed with a microorganism and the mixture of feed silage and microorganism is stored in a closed container for at least 30 days, characterized in that the feed silage is mixed with at least two microorganisms selected from the group consisting of Enterococcus faecium (DSM 3530), Lactobacillus brevis (DSM 19456), Lactobacillus plantarum (DSM 19457), Lactobacillus kefiri (DSM 19455), Trichosporon spec. nov. (DSM 14153), Trichosporon mucoides (DSM 14156), Trichosporon dulcitum (DSM 14162) and Eubacterium (DSM 11798), as well as an inorganic substance having a large internal surface area.

2. The method according to claim 1, characterized in that two microorganisms from the group of yeasts and/or bacteria, in particular each a heterofermentative microorganism and a homofermentative microorganism, and an inorganic material are used as microorganisms.

3. The method according to claim 1, characterized in that the feed silage is each supplemented with at least one microorganism from the group of bacteria and a microorganism from the group of yeasts.

4. The method according to claim 1, characterized in that the inorganic substance having a large internal surface area is selected from silicates and, in particular, aluminium silicates, diatomaceous earths, zeolites and/or bentonite.

5. The method according to claim 1, characterized in that aluminium silicate, in particular acid-treated granulated aluminium silicate, is used as said inorganic substance having a large internal surface area.

6. A feed silage additive for ruminants, containing silage of grass, cereals, maize and/or lucernes as well as a microorganism, characterized in that the feed silage additive is comprised of at least two microorganisms selected from the group consisting of Enterococcus faecium (DSM 3530), Lactobacillus brevis (DSM 19456), Lactobacillus plantarum (DSM 19457), Lactobacillus kefiri (DSM 19455), Trichosporon spec. nov. (DSM 14153), Trichosporon mucoides (DSM 14156), Trichosporon dulcitum (DSM 14162) and Eubacterium (DSM 11798), and an inorganic substance having a large internal surface area.

7. The feed silage additive according to claim 6, characterized in that the two microorganisms are selected from the group of yeasts and/or bacteria and, in particular, from each a heterofermentative microorganism and a homofermentative microorganism.

8. The feed silage additive according to claim 6, characterized in that the feed silage respectively contains equal amounts of at least one microorganism from the group of bacteria and one microorganism from the group of yeasts.

9. The feed silage additive according to claim 6, characterized in that the inorganic substance having a large internal surface area is selected from silicates and, in particular, aluminium silicates, diatomaceous earths, zeolites and/or bentonite.

10. The feed silage additive according to claim 6, characterized in that the inorganic substance having a large internal surface area is comprised of aluminium silicate, in particular acid-treated granulated aluminium silicate.
